(19) United States
(12) Patent Application Publication
(10) Pub. No.: US 2023/0359408 A1
(43) Pub. Date: Nov. 9, 2023

(54) CONTENT-BASED PRINTING

(71) Applicant: Hewlett-Packard Development Company, L.P., Spring, TX (US)

(72) Inventors: Abhishek Ghosh, Spring, TX (US); Manohar Lal Kalwani, Pune (IN); Sandip Brahmachary, Pune (IN)

(73) Assignee: Hewlett-Packard Development Company, L.P., Spring, TX (US)

(21) Appl. No.: 18/018,842

(22) PCT Filed: Aug. 19, 2021
(86) PCT No.: PCT/US2021/046681

§ 371 Date: Jan. 30, 2023

(30) Foreign Application Priority Data
Aug. 21, 2020 (IN) 202041036118

(51) Int. Cl. G06F 3/12; G06V 30/413; G06V 30/19; G06F 40/284

(52) U.S. Cl. CPC G06F 3/1222; G06V 30/413; G06V 30/19147; G06F 40/284; G06V 30/1916; G06F 3/1238; G06F 3/1288; G06F 3/1261; G06F 3/1255

(57) ABSTRACT

An image forming apparatus may include a receiving unit to receive a print request to print a document. Further, the image forming apparatus may include an extraction unit to extract content from the document. Furthermore, the image forming apparatus may include a categorization unit to determine a type of the content by applying a machine learning model to the extracted content. Further, the image forming apparatus may include a controller to manage the print request based on the type of the content.

### BACKGROUND

Image forming apparatuses, such as printers, copiers, multifunction devices, or the like, may be capable of printing documents on print media (e.g., papers). In an enterprise environment, multiple users may access an image forming apparatus, for instance, to perform a print function, a copy function, or the like. For example, the users may use the image forming apparatus to print various types of documents (e.g., personal data, confidential data, sensitive data, and/or the like).

### BRIEF DESCRIPTION OF THE DRAWINGS

Examples are described in the following detailed description and in reference to the drawings, in which:

FIG. 1A is a block diagram of an example image forming apparatus, including a controller to manage a print request based on a type of content;

FIG. 1B is a block diagram of the example image forming apparatus of FIG. 1A, depicting additional features;

FIG. 2 is a block diagram of the example image forming apparatus of FIG. 1A, depicting additional features;

FIG. 3 is an example functional diagram of an extraction unit and a categorization unit, illustrating an example to determine a type of content of a document;

FIG. 4 is a flowchart illustrating an example method for preventing an execution of a print request based on a configuration setting;

FIG. 5 is a block diagram of an example server including a non-transitory machine-readable storage medium storing instructions to manage a print request based on a category of a document;

FIG. 6 is a block diagram of an example server, including a controller to manage a print request based on a category of a document;

FIG. 7A is an example sequence diagram illustrating managing a print request based on a category of a document;

FIG. 7B is another example sequence diagram, illustrating managing a print request based on a category of a document; and

FIG. 7C is yet another example sequence diagram, illustrating generating a notification indicating a refusal of execution of a print request based on a category of a document.

### DETAILED DESCRIPTION

In an enterprise environment, multiple computing devices may be connected to various image forming apparatuses (e.g., printers, copiers, multi-function devices, or the like) over a network. Further, users may provide print requests to image forming apparatuses via a respective computing device. For example, the print requests may be to print various types of documents (e.g., personal data, confidential data, sensitive data, and/or the like).

In such environments, printing documents of different types using the image forming apparatus placed at a specific location in an enterprise may lead to privacy violations, confidential data breach, sensitive information loss, or the like. For example, printing tax related document using the image forming apparatus located at hallway of the enterprise may lead to sensitive information loss, printing official documents using the image forming apparatus located near a cafe of the enterprise may lead to confidential data breach, and the like. In other examples, the enterprise can control cost of various consumables used in an image forming apparatus by preventing printing of personal documents using the image forming apparatus. Example consumables may be ink, toner, paper, staples, binding materials, and the like.

Some example restrictive printing methods may categorize documents (e.g., a work-related file, an employee's personal file, or the like) based on file extensions of the document. Some other restrictive printing methods may categorize documents based on a name of the document. Further, based on document categorization, the print request may be suspended. In such examples, the name or extension of the document included in a print request may be monitored to determine whether the document to be printed or not via the image forming apparatus. However, a user can change the name or extension of the document in order to execute printing of the document.

Examples described herein may provide an image forming apparatus to prevent execution of a print request based on a type of content of a document. The image forming apparatus may receive the print request to print the document. Further, the image forming apparatus may extract the content from the document. Furthermore, the image forming apparatus may determine the type of the content by applying a machine learning model to the extracted content. Further, the image forming apparatus may manage the print request based on the type of the content.

In an example, the image forming apparatus may determine whether to permit execution of the print request based on the type of the content and a configuration policy of the image forming apparatus. In this example, the configuration policy may prevent printing of the document associated with the determined category. Further, the controller may suspend the execution of the print request in response to a determination that the execution of the print request is not permitted.

Examples described herein may provide a restrictive printing solution which may analyze the content of the document, categorize the document based on the content of the document using a machine learning model, and restrict the image forming apparatus from printing certain types of the document. Thus, examples described herein may prevent data breach, prevent sensitive information loss, work as a catalyst in cutting down printing cost of an enterprise, reduce ecological footprint, or the like.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

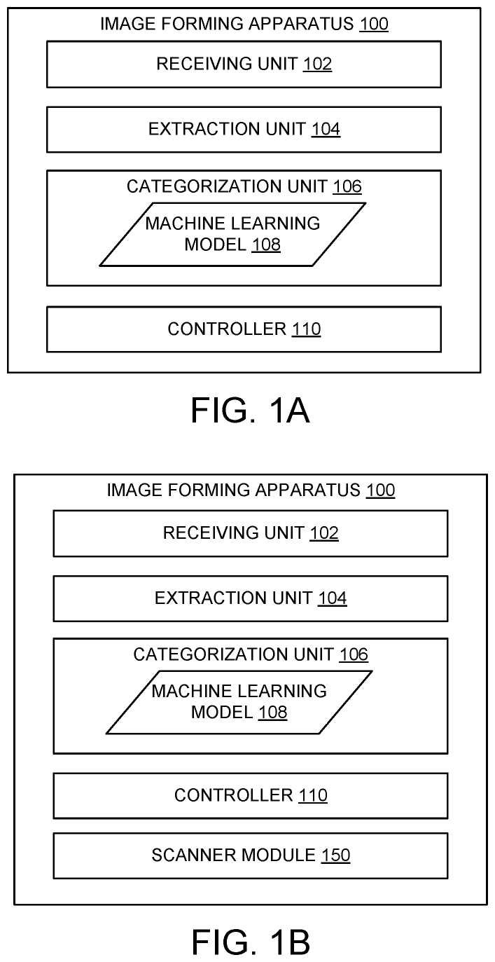

Turning now to the figures, FIG. 1A is a block diagram of an example image forming apparatus 100, including a controller 110 to manage a print request based on a type of content. As shown in FIG. 1A, image forming apparatus 100 may include a receiving unit 102 to receive the print request to print a document. In an example, the document may include a single page or multiple pages of content or print data. The content can include text data, image data, or a combination thereof. Example image data may include security marks such as a topographical watermark, a logo, a symbol, a hologram, a bar code, a two-dimensional bar-code, Braille code, a photograph, a surface texture, an emblem, a seal, or any combinations thereof.

In one example, a user may use a computing device to issue the print request to image forming apparatus 100, for instance, via a wired or wireless network. In other examples, the user may connect a storage device (e.g., a flash drive) to image forming apparatus 100 to print the document stored therein.

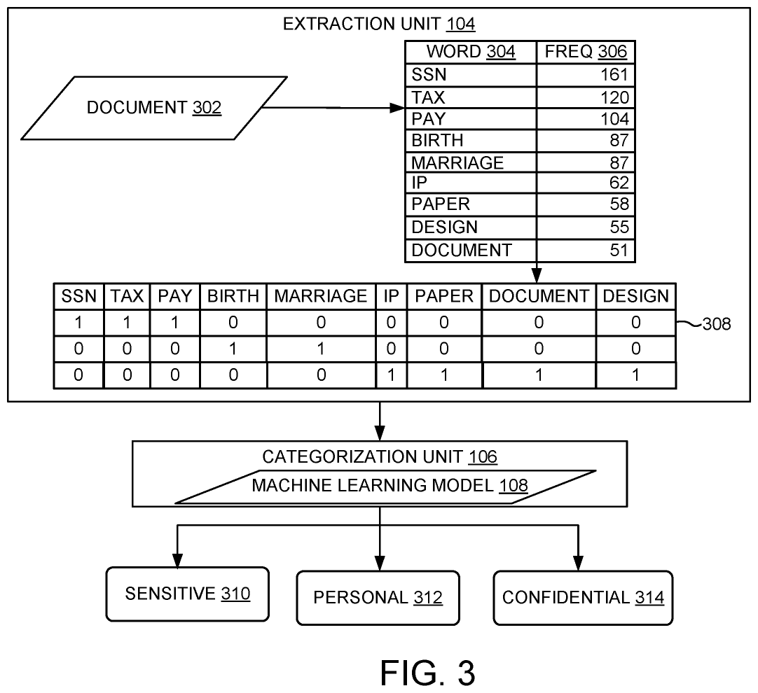

Further, image forming apparatus 100 may include an extraction unit 104 to extract the content from the document in response to receiving the print request. In an example, extraction unit 104 may generate a list of strings or words by segmenting the content in the document via natural language processing. Further, extraction unit 104 may generate tokens via tokenizing the words/strings in the list of strings and tag the tokens with parts of speech to derive input data. Example extraction of the content from the document may be described in FIG. 3.

Furthermore, image forming apparatus 100 may include a categorization unit 106 to determine a type of the content by applying a machine learning model 108 to the extracted content. In an example, machine learning model 108 may be applied to the derived input data to determine the type of the content. For example, machine learning may refer to an application of artificial intelligence (AI) that provides systems an ability to automatically learn and improve from experience without being explicitly programmed.

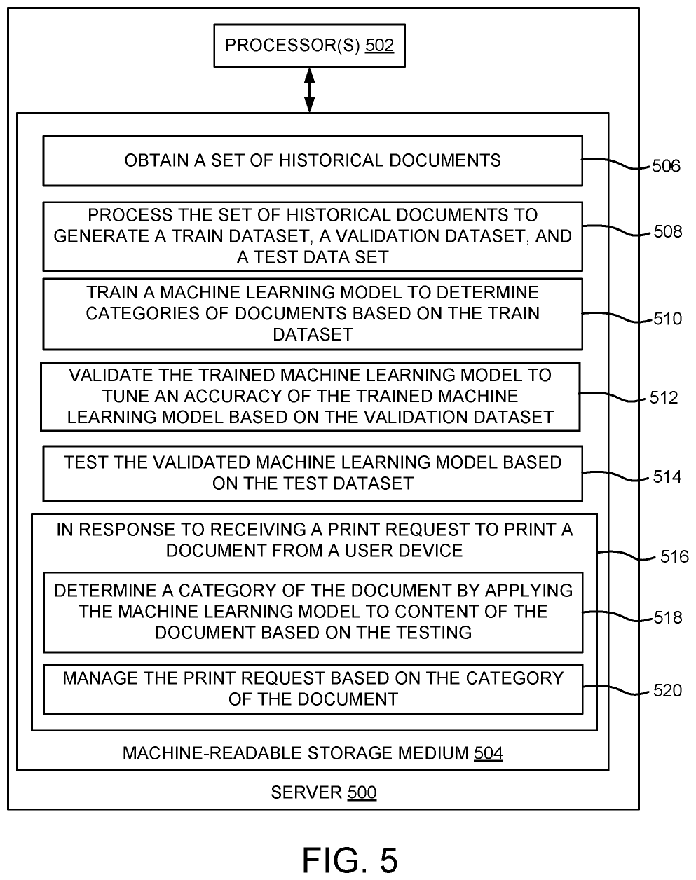

In an example, machine learning model 108 may be trained on input words and/or strings of words using machine learning and natural language processing methods to determine the type of the content. For example, the input words and/or the strings of words may be selected from a set of historical documents. Example machine learning model 108 may be a supervised machine learning model (e.g., a classification model). In supervised machine learning, machine learning model 108 may be trained using labelled training data, i.e., input data (e.g., historical documents) and associated output data (i.e., a correct category of the historical documents). Thus, machine learning model 108 may learn to predict the category of the document from the labelled training data. Example training of machine learning model 108 may be described in FIG. 5.

Further, image forming apparatus 100 may include controller 110 to manage the print request based on the type of the content. In an example, controller 110 may determine whether to permit execution of the print request based on the type of the content and a configuration policy of image forming apparatus 100. In an example, the configuration policy may include a user-enabled feature to prevent printing of the document that includes confidential data, sensitive data, personal data, or any combination thereof. Further, controller 110 may suspend the execution of the print request in response to a determination that the execution of the print request is not permitted. Examples described in FIG. 1A may also be applicable to a scan-to-print (i.e., a copy job) as explained in FIG. 1B.

FIG. 1B is a block diagram of example image forming apparatus 100 of FIG. 1A, depicting additional features. Similarly named elements of FIG. 1B may be similar in function and/or structure to elements described in FIG. 1A. As shown in FIG. 1B, image forming apparatus 100 may include a scanner module 150. Example scanner module 150 may be an input device that scans a document such as a photograph, a page of text, and the like to convert the document into an electronic version.

In some examples, image forming apparatus 100 may receive a scan-to-print job as the print request. Further, scanner module 150 may scan the document in response to receiving the scan-to-print job as the print request. Further, extraction unit 104 may convert the scanned document into a processor-readable document using optical character recognition (OCR). Furthermore, extraction unit 104 may extract the content from the processor-readable document. Upon extracting the content, categorization unit 106 may determine a type of the content by applying machine learning model 108 to the extracted content. Further, controller 110 may manage the print request based on the type of the content as described in FIG. 1A.

As used in FIGS. 1A and 1B, the term “image forming apparatus” may refer to a device that may encompass any apparatus that accepts a print request and performs at least one of the following functions or tasks: print, scan, and/or copy. Image forming apparatus 100 may be a single function peripheral (SFP) or a multi-function peripheral (MFP). Example image forming apparatus 100 can be a laser beam printer (e.g., using an electrophotographic method for printing), an ink jet printer (e.g., using an ink jet method for printing), or the like.

In some examples, the functionalities described herein, in relation to instructions to implement functions of receiving unit 102, extraction unit 104, categorization unit 106, controller 110, and any additional instructions described herein in relation to the storage medium, may be implemented as engines or modules including any combination of hardware and programming to implement the functionalities of the modules or engines described herein. The functions of receiving unit 102, extraction unit 104, categorization unit 106, and controller 110 may also be implemented by a processor. In examples described herein, processor may include, for example, one processor or multiple processors included in a single device or distributed across multiple devices. The functions of receiving unit 102, extraction unit 104, categorization unit 106, and controller 110 can also be implemented in a server that is connected to image forming apparatus 100 via a network.

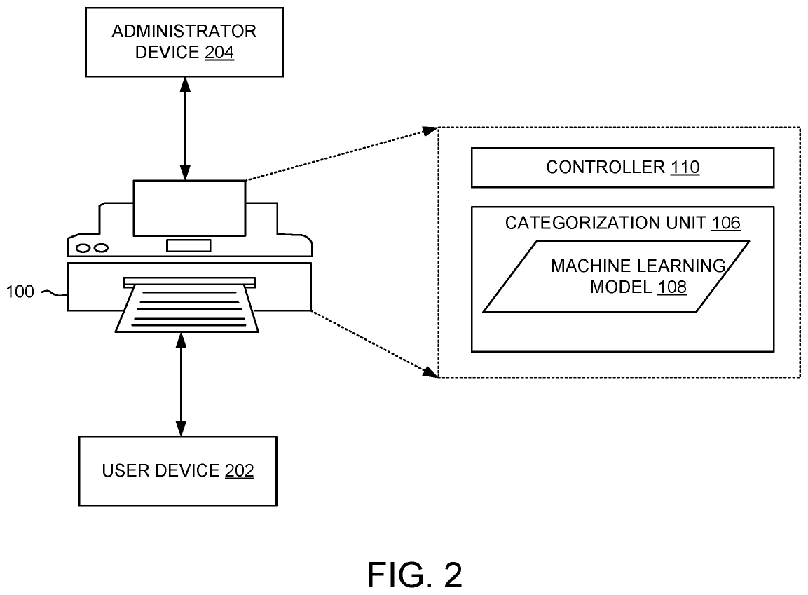

FIG. 2 is a block diagram of example image forming apparatus 100 of FIG. 1A, depicting additional features. Similarly named elements of FIG. 2 may be similar in function and/or structure to elements described in FIG. 1A. In an example, image forming apparatus 100 may be a part of a network printing environment, where multiple user devices (e.g., a user device 202) may access image forming apparatus 100 via a network. Example network may be a local area network (LAN), a wide area network (WAN), the Internet, a wired connection, and/or the like. User device 202 may be an electronic device that can be used to generate the print request. Example user device 202 may be a laptop, a desktop, a mainframe computer, a smartphone, a personal digital assistant (PDA), an Internet of Things (IoT) device, or any other device capable of generating the print request for printing.

Further, the network printing environment may be monitored/administrated by an administrator via an administrator device 204. The administrator may be responsible for managing, overseeing, and maintaining the network printing environment. For example, the administrator may configure image forming apparatus 100 to restrict printing of documents with a particular type of content. In an example, the administrator may restrict printing of documents by enabling a feature (i.e., configuration setting or toggle configuration) in image forming apparatus 100. The document may include confidential data (e.g., confidential design documents, intellectual property (IP) documents, confidential thesis papers, and the like), sensitive data (e.g., pay slips, tax related documents, and the like), personal data (e.g., birth certificates, marriage certificates, and the like), or any combination thereof.

In an example, the administrator may enable the feature based on a location of image forming apparatus 100 at an enterprise site. For example, the administrator may enable a first configuration setting (e.g., that restricts printing of sensitive data) in an image forming apparatus placed in a hallway of the enterprise to restrict printing of the documents with the sensitive data. In another example, the administrator may enable a second configuration setting (e.g., that restricts printing of the personal data) in an image forming apparatus placed at a secured zone of the enterprise where users of the image forming apparatus may not be allowed to print personal documents. In yet another example, the administrator may enable a third configuration setting (e.g., to restrict printing of confidential data) in an image forming apparatus located near a cafe of the enterprise to restrict users from printing official documents.

In an example, image forming apparatus 100 may receive the print request, determine whether to permit execution of the print request based on the type of the content and the configuration setting of image forming apparatus 100, and suspend the execution of the print request in response to a determination that the execution of the print request is not permitted. Further, controller 110 may generate a notification on a user interface in response to the suspension of the execution of the print request. Example notification may seek confirmation to enable or disable the execution of the print request based on the type of the content and/or a location of image forming apparatus 100.

In an example, the notification may be sent to administrator device 204. The administrator may then decide whether to enable or permit execution of the print request in image forming apparatus 100. When the administrator decides to permit execution of the print request, the administrator may send the confirmation to image forming apparatus 100. Further, controller 110 may execute the print request in response to receiving the confirmation. When the administrator decides to restrict the execution of the print request, a notification indicating a refusal of execution of the print request may be sent to user device 202.

In another example, the notification may be sent to user device 202. The user may then decide whether to permit execution of the print request and provide the confirmation to image forming apparatus 100 accordingly. Further, controller 110 may execute the print request in response to receiving the confirmation.

FIG. 3 is an example functional diagram of extraction unit 104 and categorization unit 106 of FIG. 1A, illustrating an example to determine a type of content of a document 302. Extraction unit 104 may extract content from document 302, which may be received for printing. In an example, extraction unit 104 may convert document 302 (e.g., document 302 may be in a format of pdf, jpg, doc, xls, or the like) to editable text using an optical character recognition, apply natural language processing and text analytics to extract the content of document 302. For example, extraction unit 104 may generate a list of strings or words by segmenting the content in document 302 via natural language processing.

In an example depicted in FIG. 3, extraction unit 104 may divide the content of document 302 into words 304 using tokenization, assign parts of speech (POS) tags to words 304, and determine frequency 306 of occurrence of the words 304 using the POS tags. Tokenization may refer to separating text of document 302 into smaller units called tokens. Here, tokens can be either words, characters, or sub words. The parts of speech tagging may refer to a process of marking up a word in a text as corresponding to a particular part of speech. The part-of-speech tag may signify whether the word is a noun, adjective, verb, and so on. Further, extraction unit 104 may extract features from the content based on the POS tagging and frequency 306 of occurrence of the words 304. The extracted features may be used to derive the input data 308.

Further, categorization unit 106 may determine the type of the content by applying machine learning model 108 to input data 308. In an example, machine learning model 108 may be trained by processing historical documents using the natural language processing and the text analytics. Thus, machine learning model 108 may understand the categories of documents based on corresponding content and may segregate documents into different categories. Example training of machine learning model 108 may be described in FIG. 5. In the example, machine learning model 108 may predict whether the content of document 302 belongs to defined categories such as “sensitive” 312, “personal” 314, or “confidential” 316 based on input data 308.

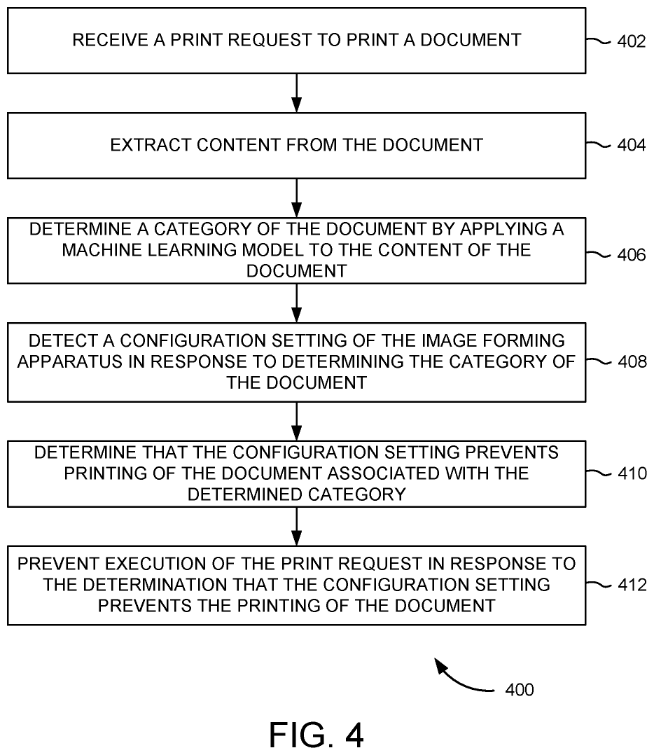

FIG. 4 is a flowchart illustrating an example method 400 for preventing execution of a print request based on a configuration setting. It should be understood that method 400 depicted in FIG. 4 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. The processes of method 400 may represent functions and/or actions performed by functionally equivalent circuits like analog circuits, digital signal processing circuits, application specific integrated circuits (ASICs), or other hardware components associated with the system. Furthermore, example method 400 may not be intended to limit the implementation of the present application, but rather example method 400 illustrates functional information to design/fabricate circuits, generate machine-readable instructions, or use a combination of hardware and machine-readable instructions to perform the illustrated processes.

At 402, a print request to print a document may be received. At 404, content may be extracted from the document. Example content may include text data, image data, or a combination thereof. In an example, extracting the content from the document may include:
converting the document into a processor-readable document using optical character recognition (OCR) when the document is not in the processor-readable document,
generating a list of strings or words by segmenting the content in the converted document via natural language processing,
generating tokens via tokenizing the words/strings in the list of strings, and
tagging the tokens with parts of speech to derive input data.

At 406, a category of the document may be determined by applying a machine learning model to the content of the document. In an example, the machine learning model may be applied to the derived input data to determine the category of the document.

At 408, a configuration setting of the image forming apparatus may be detected in response to determining the category of the document. In an example, the configuration setting of the image forming apparatus may include a user-enabled feature to prevent printing of the document that may include confidential data, sensitive data, personal data, or any combination thereof.

At 410, a check may be made to determine whether the configuration setting prevents printing of the document associated with the determined category. At 412, execution of the print request may be prevented in response to the determination that the configuration setting prevents the printing of the document. Further, a notification indicating a refusal of the execution of the print request may be transmitted to a user device in response to preventing the execution of the print request. Examples described herein may be implemented in the image forming apparatus or in a server connected to the image forming apparatus.

FIG. 5 is a block diagram of an example server 500 including non-transitory machine-readable storage medium 504 storing instructions (e.g., 506 to 520) to manage a print request based on a category of a document. Server 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 504 may be non-transitory machine-readable medium. Machine-readable storage medium 504 may be remote but accessible to server 500.

As shown in FIG. 5, machine-readable storage medium 504 may store instructions 506-520. In an example, instructions 506-520 may be executed by processor 502 to manage the print request based on the category of the document. Instructions 506 may be executed by processor 502 to obtain a set of historical documents.

Instructions 508 may be executed by processor 502 to process the set of historical documents to generate a train dataset, a validation dataset, and a test data set. In an example, instructions to process the set of historical documents may include instructions to process the set of historical documents to generate input text data, input image data, or a combination thereof and generate the train dataset, the validation dataset, and the test dataset using the input text data, input image data, or a combination thereof.

Instructions 510 may be executed by processor 502 to train a machine learning model to determine categories of documents based on the train dataset. Instructions 512 may be executed by processor 502 to validate the trained machine learning model to tune an accuracy of the trained machine learning model based on the validation dataset. Instructions 514 may be executed by processor 502 to test the validated machine learning model based on the test dataset. In an example, the tested machine learning model may be used in image forming apparatuses or servers to determine the category of documents associated with upcoming print requests when an accuracy of testing is greater than a threshold (e.g., a user defined threshold).

Instructions 516 may be executed by processor 502 to receive a print request to print a document from a user device. In response to receiving the print request, instructions 518 and 520 are executed. Further, instructions 518 may be executed by processor 502 to determine a category of the document by applying the trained and tested machine learning model to content of the document.

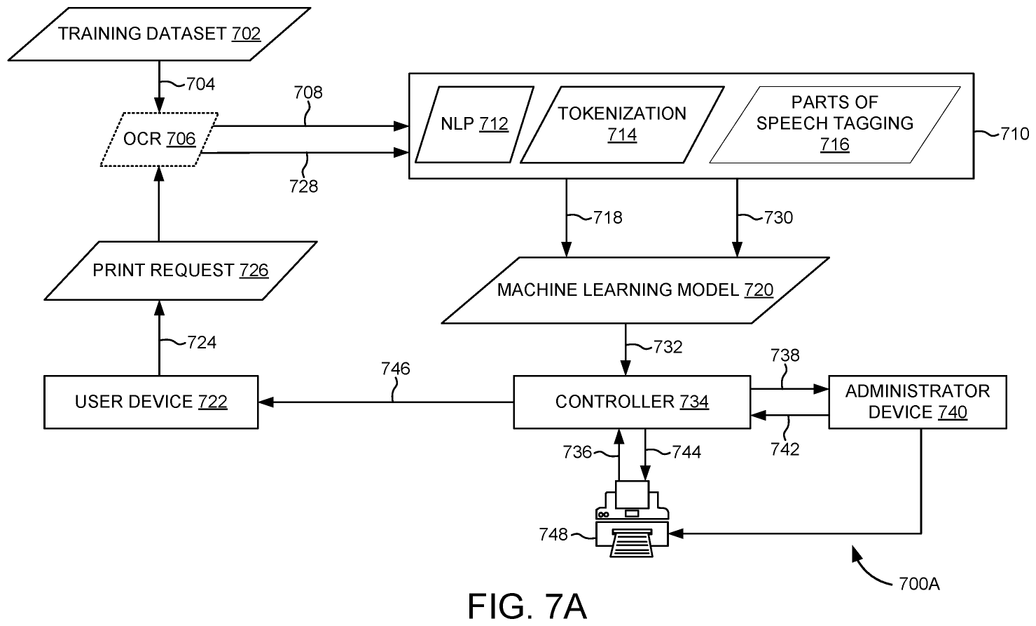

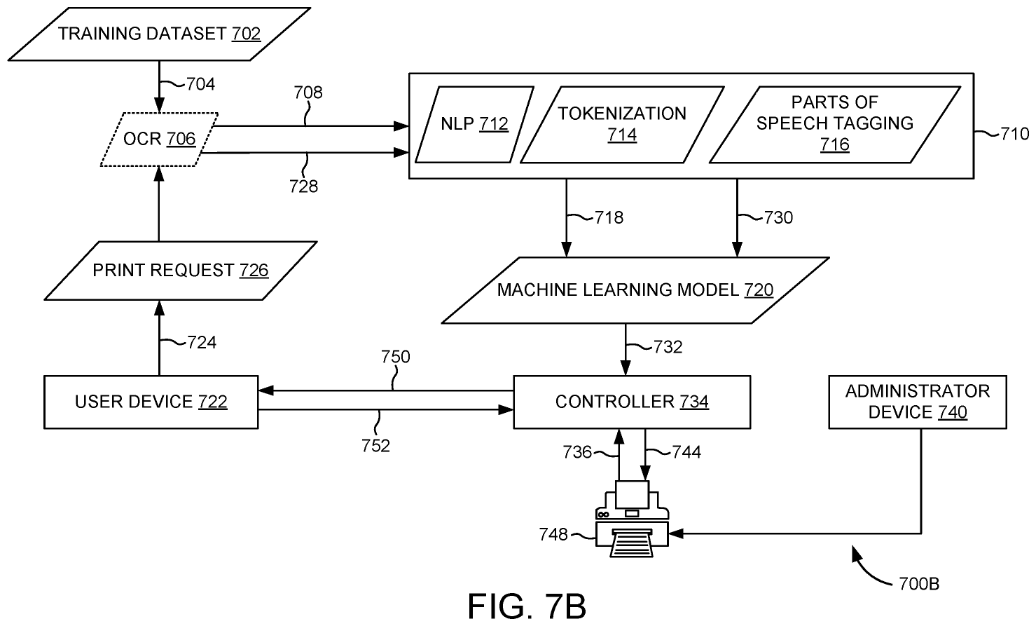

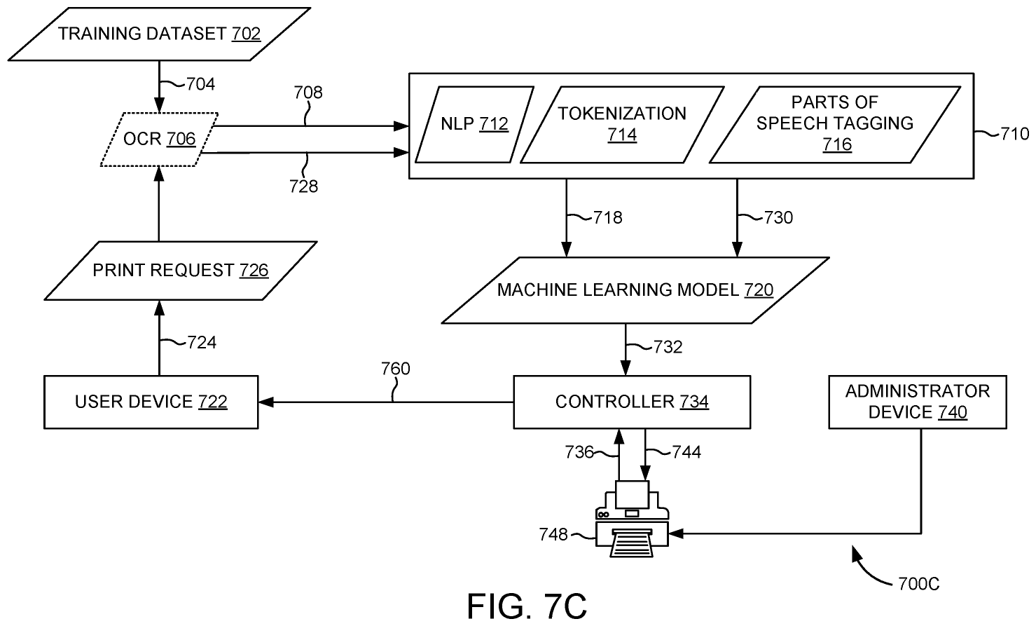

Furthermore, instructions 520 may be executed by processor 502 to manage the print request based on the category of the document. In an example, instructions to manage the print request may include instructions to:
determine a configuration setting of an image forming apparatus that prevents printing of the document associated with the determined category,
transmit a notification in response to the determination that the configuration setting prevents the printing of the document. Example notification may be to seek confirmation to execute the print request on the image forming apparatus based on the category of the document and/or a location of the image forming apparatus (e.g., example scenario is described in FIGS. 7A and 7B),
receive feedback data including the confirmation or a refusal of the execution of the print request corresponding to the notification, and
retrain the machine learning model using the feedback data to tune the machine learning model.

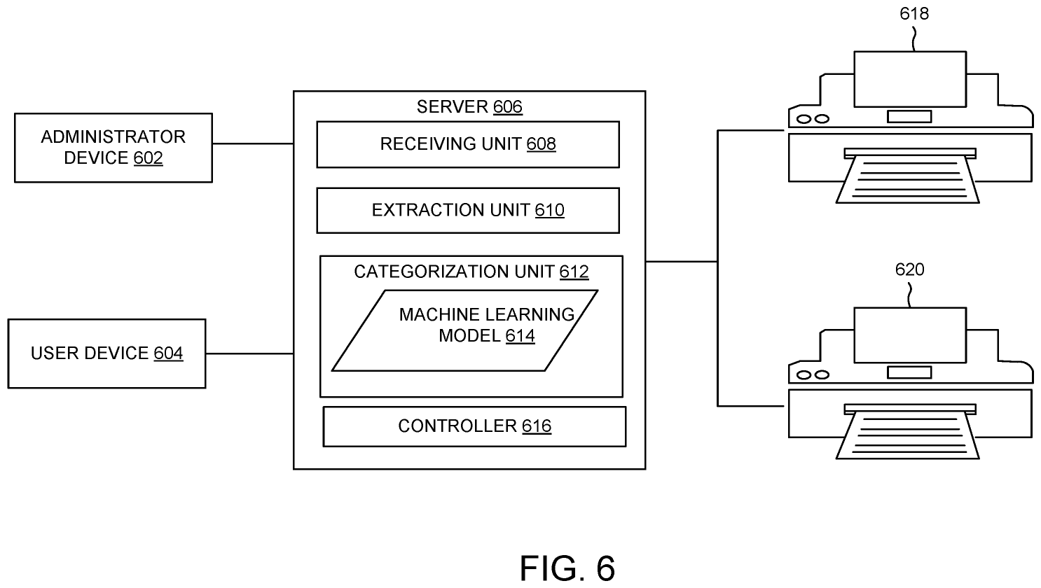

In another example, instructions to manage the print request may include instructions to:
determine a configuration setting of an image forming apparatus that prevents printing of the document associated with the determined category,
transmit a notification in response to the determination that the configuration setting prevents the printing of the document. Example notification may to seek confirmation to redirect the print request to another image forming apparatus that is suitable for printing the document associated with the determined category (e.g., example scenario is described in FIG. 6), and
redirect the print request to another image forming apparatus in response to receiving the confirmation.

In yet another example, instructions to manage the print request may include instructions to:
determine a configuration setting of an image forming apparatus that prevents printing of the document associated with the determined category, and
transmit a notification in response to the determination that the configuration setting prevents the printing of the document. Example notification is to indicate a refusal of the execution of the print request (e.g., example scenario is described in FIG. 7C).

Thus, examples described herein may allow/disallow execution of the print request via enabling or disabling the configuration setting on the image forming apparatus. Further, examples described herein may provide configuration policy driven mechanism that not only requests administrators to approve the print request but also provides the category of the document and associated content through machine learned predictions and seek confirmation from users. Examples described herein may use the user feedback to further retrain the data through the machine learning model. Further, examples described herein can be implemented in image forming apparatuses used for financial, military, and government purposes as well as image forming apparatuses in public places to prevent the printing of sensitive documents.

FIG. 6 is a block diagram of an example server 606, including a controller 616 to manage a print request based on a category of a document. As shown in FIG. 6, server 606 may be communicatively connected to a user device 604 and multiple image forming apparatuses 618 and 620 via a network (e.g., Internet). Further, server 606 may be managed by an administrator via an administrator device 602. Example server 606 may be a local area network server, a cloud print server, or the like.

As shown in FIG. 6, server 606 may include a receiving unit 608, an extraction unit 610, a categorization unit 612, and a controller 616. During operation, receiving unit 608 may receive a print request from user device 604. The print request may be to print a document on image forming apparatus 618. Further, extraction unit 610 may process the document to extract content from the document. Based on the extracted content of the document, categorization unit 612 may determine a category of the document using a machine learning model 614 and provide category information to controller 616.

Further, controller 616 may manage the print request based on the category information. In an example, controller 616 may determine a configuration setting of image forming apparatus 618 that prevents printing of the document associated with the determined category. Further, controller 616 may transmit a notification in response to the determination that the configuration setting of image forming apparatus 618 prevents the printing of the document. In an example, the notification may seek confirmation from a user (e.g., via user device 604) or an administrator (e.g., via administrator device 602) to redirect the print request to another image forming apparatus 620 that is suitable for printing the document associated with the determined category. Upon receiving the confirmation, controller 616 may redirect the print request to image forming apparatus 620.

In another example, the notification may be to seek confirmation from a user (e.g., via user device 604) or administrator (via administrator device 602) to execute the print request on image forming apparatus 618 based on the category of the document and/or a location of image forming apparatus 618. Further, controller 616 may receive feedback data including the confirmation or a refusal of the execution of the print request corresponding to the notification. When the user or administrator confirms to execute the print request via image forming apparatus 618, the print request may be executed via image forming apparatus 618 and also machine learning model 614 may be retrained using the feedback data to tune the machine learning model 614.

FIG. 7A is an example sequence diagram 700A illustrating managing a print request based on a category of a document. Initially, a machine learning model 720 may be trained using a training dataset 702. At 704, a training dataset 702 may be provided to an optical character recognition (OCR) unit 706 to convert documents in training dataset 702 into editable formats. In an example, training dataset 702 may include documents with different formats (e.g., pdf, jpeg, doc, and the like). For example, the documents such as birth certificates, passports, visas, tax documents, pay stubs, documents with photos, marriage certificates, official documents with flow diagrams, design documents, documents with watermark, and the like can be used as training dataset 702.

At 708, editable formats of training documents may be sent for further processing. At 710, content from the editable formats of documents may be extracted using natural language processing (NLP) and text analytics. For example, a list of words may be generated by segmenting the content in the document via NLP 712. Further, tokens may be generated via tokenization 714 the words in the list of words. Furthermore, the tokens may be tagged with parts of speech 716 to derive input data. At 718, the input data and corresponding classifications may be used to train machine learning model 720 (e.g., using supervised machine learning). For example, machine learning model 720 may be built based on a 60-20-20 rule on training dataset 702, i.e. 60% of the documents may be used for training or building machine learning model 720. Further, 20% may be used for validating machine learning model 720 to rectify parameters and finalize machine learning model 720 to get enhance accuracy, recall, and precession values. Furthermore, the rest 20% may be used for testing machine learning model 720.

During operation, at 724, a user may provide a print request 726 for printing a document via a user device 722. Further, a type of the document may be identified based on an extension of the document. Upon identifying the type, the document may be converted into editable format through OCR unit 706 when the document is not in the editable format. At 728, the editable format of the document may be sent for further processing.

At 710, content from the editable format of the document may be processed using NLP 712, tokenization 714, and parts of speech tagging 716 to derive input data. At 730, the input data may be provided to trained and tested machine learning model 720. In an example, the trained and tested machine learning model 720 may determine a category of the document based on the input data. For example, machine learning model 720 may be able to intelligently identify any watermarks as “highly-confidential”, “confidential”, “public” or may even identify holograms, workflow process diagram, photographs, emails, and the like to determine the category of the document.

At 732, the category of the document may be communicated to a controller 734. At 736, controller 734 may determine/obtain a configuration policy from an image forming apparatus 748. In an example, the administrator may configure the configuration policy of image forming apparatus 748. Further, controller 734 may determine whether to permit execution of print request 726 based on the category of the document and the configuration policy of image forming apparatus 748.

When controller 734 determines that the execution of print request 726 is not permitted, at 738, controller 734 may transmit a notification to an administrator device 740 to seek confirmation of execution of print request 726 on image forming apparatus 748 based on the category of the document and/or a location of image forming apparatus 748. The notification may be transmitted through an email, a pop-up window, or any other feedback mechanism. At 742, controller 734 may receive administrator's confirmation. At 744, controller 734 may allow printing of the document. Further, the feedback data may be then used to retrain machine learning model 720 for accuracy tuning. When the administrator refuses the execution of print request 726, at 746, a notification indicating refusal of execution of print request 726 may be sent to user device 722

FIG. 7B is another example sequence diagram 700B, illustrating managing print request 726 based on a category of the document. Similarly named elements of FIG. 7B may be similar in function and/or structure to elements described in FIG. 7A. In the example shown in FIG. 7B, the notification seeking confirmation may be sent to user device 722 instead of administrator device 740. When controller 734 suspends the execution of print request 726, at 750, controller 734 may transmit a notification to user device 722 seeking confirmation to print the document on image forming apparatus 748 based on the category of document and/or the location of image forming apparatus 748 through email or any other feedback mechanism.

Upon user confirmation at 752, controller 734 may allow the execution of print request 726 on image forming apparatus 748. Further, feedback data may be then used to retrain machine learning model 720 for accuracy tuning. In another example, the user can also redirect print request 726 to another image forming apparatus located at different location based on the category of the document and the notification.

FIG. 7C is yet another example sequence diagram 700C, illustrating generating a notification indicating a refusal of execution of a print request based on a category of the document. Similarly named elements of FIG. 7C may be similar in function and/or structure to elements described in FIG. 7A. In an example, upon determining that machine learning model 720 is reliable over time and the accuracy of machine learning model 720 is satisfactory, the decision of machine learning model 720 may be used to self-train through unsupervised learning. In this scenario, when controller 734 determines that the execution of print request 726 is not permitted, controller 734 may transmit a notification to user device 722 to indicate a refusal of the execution of print request 726, at 760.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. An image forming apparatus comprising:
a receiving unit to receive a print request to print a document;
an extraction unit to extract content from the document;
a categorization unit to determine a type of the content by applying a machine learning model to the extracted content; and
a controller to manage the print request based on the type of the content.

2. The image forming apparatus of claim 1, wherein the extraction unit is to:
generate a list of strings or words by segmenting the content in the document via natural language processing;
generate tokens via tokenizing the words/strings in the list of strings; and
tag the tokens with parts of speech to derive input data, wherein the machine learning model is applied to the derived input data to determine the type of the content.

3. The image forming apparatus of claim 1, wherein the machine learning model is trained on input words and/or strings of words using machine learning and natural language processing methods to determine the type of the content, and wherein the input words and/or the strings of words are selected from a set of historical documents.

4. The image forming apparatus of claim 1, wherein the controller is to:
determine whether to permit execution of the print request based on the type of the content and a configuration policy of the image forming apparatus; and
suspend the execution of the print request in response to a determination that the execution of the print request is not permitted.

5. The image forming apparatus of claim 4, wherein the controller is to:
generate a notification on a user interface in response to the suspension of the execution of the print request, wherein the notification is to seek confirmation to enable or disable the execution of the print request based on the type of the content and/or a location of the image forming apparatus; and
execute the print request in response to receiving the confirmation.

6. The image forming apparatus of claim 1, further comprising:
a scanner module to scan the document in response to receiving a scan-to-print job as the print request, wherein the extraction unit is to:
convert the scanned document into a processor-readable document using optical character recognition (OCR); and
extract the content from the processor-readable document.

7. A method comprising:
receiving a print request to print a document;
extracting content from the document, wherein the content comprises text data, image data, or a combination thereof;
determining a category of the document by applying a machine learning model to the content of the document;
detecting a configuration setting of the image forming apparatus in response to determining the category of the document;
determining that the configuration setting prevents printing of the document associated with the determined category; and
preventing execution of the print request in response to the determination that the configuration setting prevents the printing of the document.

8. The method of claim 7, wherein the configuration setting of the image forming apparatus comprises a user-enabled feature to prevent printing of the document that includes confidential data, sensitive data, personal data, or any combination thereof.

9. The method of claim 7, further comprising:
transmitting a notification indicating a refusal of the execution of the print request to a user device in response to preventing the execution of the print request.

10. The method of claim 7, wherein extracting the content from the document comprises:
converting the document into a processor-readable document using optical character recognition (OCR);
generating a list of strings or words by segmenting the content in the converted document via natural language processing;
generating tokens via tokenizing the words/strings in the list of strings; and
tagging the tokens with parts of speech to derive input data, wherein the machine learning model is applied to the derived input data to determine the category of the document.

11. A non-transitory machine-readable storage medium encoded with instructions that, when executed by a processor of a server, cause the processor to:
obtain a set of historical documents;
process the set of historical documents to generate a train dataset, a validation dataset, and a test data set;
train a machine learning model to determine categories of documents based on the train dataset;
validate the trained machine learning model to tune an accuracy of the trained machine learning model based on the validation dataset;
test the validated machine learning model based on the test dataset; and
in response to receiving a print request to print a document from a user device,
determine a category of the document by applying the trained and tested machine learning model to content of the document; and
manage the print request based on the category of the document.

12. The non-transitory machine-readable storage medium of claim 11, wherein instructions to manage the print request comprise instructions to:
determine a configuration setting of an image forming apparatus that prevents printing of the document associated with the determined category;
transmit a notification in response to the determination that the configuration setting prevents the printing of the document, wherein the notification is to seek confirmation to execute the print request on the image forming apparatus based on the category of the document and/or a location of the image forming apparatus;
receive feedback data including the confirmation or a refusal of the execution of the print request corresponding to the notification; and
retrain the trained and tested machine learning model using the feedback data to tune the trained and tested machine learning model.

13. The non-transitory machine-readable storage medium of claim 11, wherein instructions to manage the print request comprise instructions to:
determine a configuration setting of an image forming apparatus that prevents printing of the document associated with the determined category;
transmit a notification in response to the determination that the configuration setting prevents the printing of the document, wherein the notification is to seek confirmation to redirect the print request to another image forming apparatus that is suitable for printing the document associated with the determined category; and
redirect the print request to another image forming apparatus in response to receiving the confirmation.

14. The non-transitory machine-readable storage medium of claim 11, wherein instructions to manage the print request comprise instructions to:
determine a configuration setting of an image forming apparatus that prevents printing of the document associated with the determined category; and
transmit a notification in response to the determination that the configuration setting prevents the printing of the document, wherein the notification is to indicate a refusal of the execution of the print request.

15. The non-transitory machine-readable storage medium of claim 11, wherein instructions to process the set of historical documents comprise instructions to:
process the set of historical documents to generate input text data, input image data, or a combination thereof; and
generate the train dataset, the validation dataset, and the test dataset using the input text data, input image data, or a combination thereof.
